(19) United States
(12) Patent Application Publication
(10) Pub. No.: US 2025/0129202 A1
(43) Pub. Date: Apr. 24, 2025

(54) SOLID PROPELLANT BINDER COMPOSITION FOR THREE-DIMENSIONAL NETWORK

(71) Applicant: AGENCY FOR DEFENSE DEVELOPMENT, Daejeon (KR)

(72) Inventors: Byoung Sun MIN, Daejeon (KR); Sung June KIM, Daejeon (KR)

(21) Appl. No.: 18/521,960

(22) Filed: Nov. 28, 2023

(30) Foreign Application Priority Data
Oct. 19, 2023 (KR) 10-2023-0140394

(51) Int. Cl. C08G 18/64; C08G 18/73; C08G 18/75

(52) U.S. Cl. CPC C08G 18/6415; C08G 18/73; C08G 18/757

(57) ABSTRACT

The present disclosure provides a solid propellant binder composition for a three-dimensional network of an azide polymer comprising hydroxyl termini, which connects the ends of the azide polymer with urethane groups formed by reaction with a difunctional isocyanate compound, and connects the azide groups in the side chain of the azide polymer with a triazole or triazoline formed by reaction with a difunctional alkyne or alkene, or with an asymmetric difunctional alkyne compound, to finally cure the azide polymer into a three-dimensional network structure, thereby improving the mechanical properties of the polymer network and enhancing the energy of the propellant to which the azide polymer is applied, while being less affected by the external environment.

### CROSS-REFERENCE TO RELATED APPLICATION

This application claims priority to Korean Patent Application No. 10-2023-0140394 filed on Oct. 19, 2023, and all the benefits accruing therefrom under 35 U.S.C. § 119, the contents of which is incorporated by reference in its entirety.

### TECHNICAL FIELD

The present disclosure relates to a solid propellant binder composition for a three-dimensional network. In more detail, the present disclosure relates to a solid propellant binder composition for a three-dimensional network of an azide polymer comprising hydroxyl termini.

### BACKGROUND ART

An azide polymer comprising azide groups within the molecular chain, especially glycidyl azide polymer (GAP), has hydroxyl groups at the end of the chain and serves as a binder with a three-dimensional network by urethane groups formed by reaction with a di- or polyfunctional isocyanate compound under a urethane curing system, a typical curing system for solid propellants.

An azide polymer comprising dozens of azide groups within the molecular chain has many advantages such as improving the propellant combustion rate and specific impulse, as compared to the polymers widely used in conventional solid propellants, such as hydroxyl-terminated polybutadiene, polyethylene glycol, hydroxyl-terminated polyether and polycaprolactone.

However, due to the side chain comprising azide groups in the molecular chain, when manufactured as a binder by using an isocyanate curing agent, the azide polymer has poorer mechanical properties such as tensile strength and elongation than other polymers, thereby lowering the mechanical properties of the solid propellant to which the azide polymer is applied.

In order to improve the mechanical properties of the azide polymer, the mechanical properties of the azide polymer binder may be improved to some extent by mixing di- and tri-functional isocyanate compounds at an appropriate ratio and using same as an isocyanate curing agent. However, the problem that has always arisen when using an isocyanate compound as a binder curing agent is that, when an isocyanate compound, especially a trifunctional isocyanate compound, is exposed to air for a certain period of time, the isocyanate compound itself hardens and the isocyanate functionality is significantly reduced, and the network quality of the binder deteriorates. Thus, there was a limitation in the process of manufacturing a urethane-based binder that external moisture should be always suppressed as much as possible.

Meanwhile, such an environment in which external moisture is suppressed induces the generation of static electricity, which may pose a significant threat to safety when manufacturing propellants in the future. In addition, curing azide polymer with urethane groups has the disadvantage that the azide content in the molecular structure is reduced, thereby reducing the energy content.

### SUMMARY OF THE INVENTION

An objective of the present disclosure is to provide a solid propellant binder composition for a three-dimensional network.

Another objective of the present disclosure is to provide a solid propellant binder composition less affected by external environments such as moisture in the air.

Another objective of the present disclosure is to provide a solid propellant binder composition with improved mechanical properties of a polymer network which were poor due to side chains of an azide polymer.

Another objective of the present disclosure is to provide a solid propellant binder composition which produces triazole or triazoline groups, which are multiple nitrogen ring compounds that emit high amounts of heat during combustion within the network, to finally enhance the energy of the propellant to which the azide polymer is applied.

The objectives of the present disclosure are not limited to the objects described above and other objectives will be clearly understood by those skilled in the art from the following description.

In order to achieve the above-described objectives, there is provided a solid propellant binder composition comprising, as a prepolymer, an azide polymer containing hydroxyl groups at both ends and azide groups in the side chain; a difunctional isocyanate compound as a urethane curing agent; and a triazole or triazoline curing agent.

The azide polymer may be represented by the following formula 1:

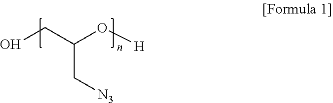

wherein in the formula 1, n is an integer from 10 to 20.

The difunctional isocyanate compound may be selected from the group consisting of isophorone diisocyanate (IPDI), dimeric diisocyanate (DDI), and hexamethylene diisocyanate (HDI).

The triazole or triazoline curing agent may be a compound selected from the group consisting of a compound comprising an alkyne group, a compound comprising an alkene group, or a combination thereof.

In addition, there is provided a solid propellant binder composition comprising, as a prepolymer, an azide polymer containing hydroxyl groups at both ends and azide groups in the side chain; a difunctional isocyanate compound as a urethane curing agent; and a compound containing an alkyne group as a triazole curing agent, wherein the compound containing the alkyne group is represented by the following formula 2 or formula 3:

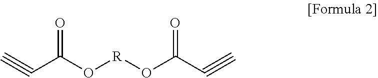

wherein in the formula 2, R is an alkylene group having 1 to 10 carbon atoms or polycaprolactone having a molecular weight of 300 to 1000 g/mol.

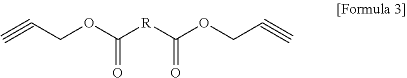

wherein in the formula 3, R is an alkylene group having 1 to 10 carbon atoms.

The compound represented by formula 2 or 3 may be present in an amount of 0.5 to 15% by weight with respect to the total composition.

In addition, there is provided a solid propellant binder composition comprising, as a prepolymer, an azide polymer containing hydroxyl groups at both ends and azide groups in the side chain; a difunctional isocyanate compound as a urethane curing agent; and a compound containing an alkene group as a triazoline curing agent, wherein the compound containing the alkene group is represented by the following formula 4:

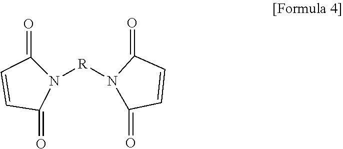

wherein in the formula 4, R is phenylene or methylene di-4,1-phenylene.

The compound represented by formula 4 may be present in an amount of 0.5 to 10% by weight with respect to the total composition.

In addition, there is provided a solid propellant binder composition comprising, as a prepolymer, an azide polymer containing hydroxyl groups at both ends and azide groups in the side chain; a difunctional isocyanate compound as a urethane curing agent; and a compound containing an alkyne group as a triazole curing agent, wherein the compound containing the alkyne group is represented by the following formula 5:

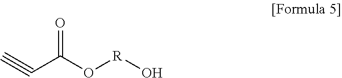

wherein in the formula 5, R is an alkylene group having 1 to 10 carbon atoms.

The compound represented by formula 5 may be present in an amount of 0.5 to 15% by weight with respect to the total composition.

The solid propellant binder composition may comprise any one selected from the group consisting triphenyl bismuth (TPB), di-nitro salicylic acid (DNSA), and a combination thereof, as a urethane curing catalyst.

In addition, the present disclosure provides a method for producing a solid propellant, comprising mixing the above-described composition followed by curing.

In addition, the present disclosure provides a solid propellant comprising the above-described composition.

According to the present disclosure, there is provided a solid propellant binder composition which improves the mechanical properties of the polymer network which were poor due to side chains of an azide polymer, while being less affected by external environments such as moisture in the air, and produces triazole or triazoline groups, which are multiple nitrogen ring compounds that emit high amounts of heat when burned within the network, thereby finally improving the energy of the propellant to which the azide polymer is applied.

The effects of the present disclosure are not limited thereto and it should be understood that the effects include all effects that can be inferred from the configuration of the present disclosure described in the following specification or claims.

### DETAILED DESCRIPTION OF THE EMBODIMENTS

Hereinafter, preferred embodiments of the present disclosure will be described with reference to accompanying drawings.

The advantages and features of the present disclosure, and methods of achieving them will be clear by referring to the exemplary embodiments that will be described hereafter in detail with reference to the accompanying drawings.

However, the present disclosure is not limited to the exemplary embodiments described hereafter and may be implemented in various ways, and the exemplary embodiments are provided to complete the description of the present disclosure and let those skilled in the art completely know the scope of the present disclosure and the present disclosure is defined by claims.

Further, when it is determined that well-known technologies, etc. may make the scope of the present disclosure unclear, they will not be described in detail in the following description.

Hereinafter, the present disclosure is described in detail.

The present disclosure provides a solid propellant binder composition comprising, as a prepolymer, an azide polymer containing hydroxyl groups at both ends and azide groups in the side chain; a difunctional isocyanate compound as a urethane curing agent; and a compound containing an alkyne group or an alkene group as a triazole or triazoline curing agent.

The azide polymer may be represented by the following formula 1:

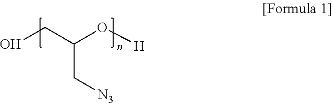

wherein in the formula 1, n is an integer from 10 to 20.

The difunctional isocyanate compound which reacts with the hydroxyl groups at both ends of the azide polymer may be selected from the group consisting of isophorone diisocyanate (IPDI), dimeric diisocyanate (DDI), and hexamethylene diisocyanate (HDI), preferably isoprone diisocyanate (IPDI) represented by the following formula a:

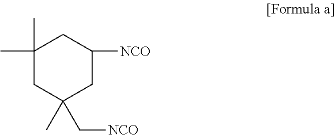

The triazole or triazoline curing agent which reacts with the azide groups in the side chain of the azide polymer may be a compound selected from the group consisting of a compound comprising an alkyne group, a compound comprising an alkene group, and a combination thereof.

The compound comprising the alkyne group as a difunctional alkyne compound may be represented by the following formula 2 or 3:

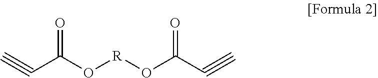

wherein in the formula 2, R is an alkylene group having 1 to 10 carbon atoms or polycaprolactone having a molecular weight of 300 to 1000 g/mol.

The polycaprolactone can be represented by the following formula 2a:

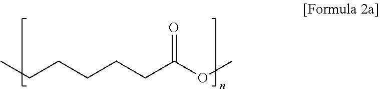

wherein in the Formula 2a, n is an integer from 15 to 20.

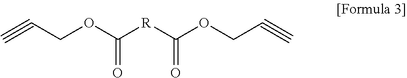

wherein in the formula 3, R is an alkylene group having 1 to 10 carbon atoms.

The compound represented by formula 2 or 3 may be 0.5 to 15% by weight, preferably 0.5 to 10% by weight, with respect to the total composition. If the compound represented by formula 2 or 3 is present in less than the above-described amount, there may be a problem that the composition is not cured, and, if it is present in more than the above-described amount, there may be a problem that the crosslinking density is too high such that the composition loses elastic properties.

The compound comprising the alkene group may be a difunctional alkene compound represented by the following formula 4:

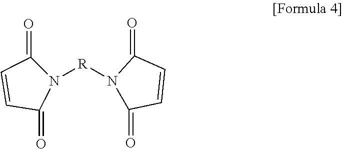

wherein in the formula 4, R is phenylene or methylene di-4,1-phenylene.

The compound represented by formula 4 may be 0.5 to 10% by weight, preferably 0.5 to 5.0% by weight, with respect to the total composition. If the compound represented by formula 4 is present in less than the above-described amount, there may be a problem that the crosslink density decreases such that the composition is not cured, and if it is present in excess of the above-described amount, there may be a problem that the crosslink density is high such that the composition loses elasticity.

In addition, the compound comprising the alkyne group as an asymmetric difunctional compound is represented by the following formula 5:

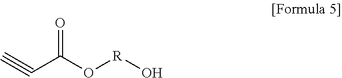

wherein in the formula 5, R is an alkylene group having 1 to 10 carbon atoms.

In the present disclosure, the hydroxyl groups at the ends of the azide polymer of formula 1 may be reacted with the above-described difunctional isocyanate compound to link the polymer chain ends, and the azide groups in the side chain of the azide polymer may reacted with a difunctional alkyne compound of formula 2 or 3 or a difunctional alkene compound of formula 4 to connect each side chain with a triazole or triazoline, thereby finally produce a binder with a three-dimensional network structure.

In addition, the hydroxyl groups at the end of the azide polymer of formula 1 may reacted with the above-described difunctional isocyanate compound to link the polymer chain ends, and the azide groups in the side chain of the azide polymer may reacted with the asymmetric difunctional compound of formula 5, which is a compound having an alkyne group at one end and a hydroxyl group at the other end, thereby finally producing a binder having a three-dimensional network structure. The binder prepared in this way wherein the hydroxyl groups at the end of the azide polymer may react with a difunctional isocyanate compound and may be connected with urethane groups, and some of the hydroxyl groups at the end of the azide polymer, together with the hydroxyl groups of formula 5, may be connected to the urethane groups formed by reaction with a difunctional isocyanate, thereby finally forming a network structure connected to a chain modified with a triazole group.

The solid propellant binder composition of the present disclosure may comprise any one selected from the group consisting of triphenyl bismuth (TPB), di-nitro salicylic acid (DNSA), and a combination thereof as a urethane curing catalyst. The urethane curing catalyst may be present in an amount of 0.01 to 1% by weight, preferably 0.05 to 0.5% by weight, with respect to the total composition. If it is present in less than the above-described amount, there may be a problem that curing does not occur, and, if it is present in excess of the above-described amount, there may be a problem in that curing occurs too quickly.

The present disclosure provides a method for producing a solid propellant, comprising mixing the above-described solid propellant binder composition followed by curing.

The mixing step may be performed at 35 to 60° C. Specifically, before adding insoluble solids such as oxidizing agents at the beginning of mixing, they may be mixed under vacuum at 50 to 60° C., and, when adding the oxidizing agents sequentially, the oxidizing agents may be sequentially added in order from large particles to small particles under vacuum at 50 to 60° C., followed by addition of a curing agent and a curing catalyst and mixing to prepare a propellant slurry.

The curing step of the prepared slurry may be performed at 50 to 60° C. for 5 to 10 days. Preparation in the above-described temperature range has the advantage that the viscosity of the propellant is low, and the mixing process and the charging efficiency are excellent.

The present disclosure provides a solid propellant comprising the above-described solid propellant binder composition.

Specific details about the solid propellant binder composition overlap with what was described above and, thus, will be omitted.

The solid propellant is not limited as long as it comprises the solid propellant binder composition described above, and its production method, form, or use may follow those commonly used in the technical field of the present disclosure.

### EXAMPLES

Hereinafter, preferred embodiments are proposed to help understand the present disclosure, but the following embodiments just exemplify the present disclosure and the scope of the present disclosure is not limited to the following embodiments. The following embodiments may be appropriately modified and changed by those skilled in the art within the scope of the present disclosure.

Representative compounds used in the following Examples and Comparative Examples are shown in Table 1 below.

TABLE 1

| Compound name | Formula No. | Formula |
|---|---|---|
| Azide polymer GAP (glycidyl azide polymer) | Formula 1 | 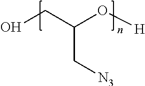 |
| Difunctional alkyne | Formula 2 | 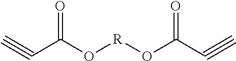 |
| Difunctional alkyne | Formula 3 | 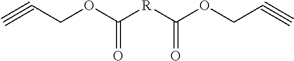 |
| Difunctional alkene | Formula 4 | 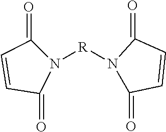 |
| Asymmetric difunctional alkyne | Formula 5 | 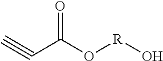 |
| Difunctional isocyanate IPDI (isophorone diisocyanate) | Formula a | 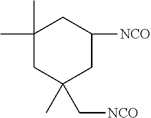 |
| Trifunctional isocyanate N-100 | Formula b | 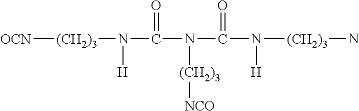 |

### Comparative Example 1

IPDI of formula a and N-100 of formula b were added to a difunctional hydroxyl-terminated glycidyl azide polymer (GAP) at the mixing ratio shown in Table 2 below, and triphenyl bimuth (TPB) and dinitro salicylic acid (DNSA) as catalysts were added in an amount of 0.1% by weight and 0.05 wt % by weight, respectively, and vacuum mixed, followed by curing at 50° C. The equivalent ratio (—NCO/—OH) of the hydroxyl groups at the end of the azide polymer and the isocyanate curing agent (IPDI and N-100) was set to 1.1.

TABLE 2

| | Ratio of | | | | |
|---|---|---|---|---|---|
| | curing agent | | | Elastic | Hardness |
| | (weight ratio: | Elongation | Tensile | modulus | (Shore |
| | N-100/IPDI) | (%) | (MPa) | (MPa) | A2) |
| Comparative | 2/1 | 106 | 4.5 | 7.1 | 33 |
| Example 1-1 | | | | | |
| Comparative | 1/1 | 235 | 4.1 | 1.9 | 22 |
| Example 1-2 | | | | | |
| Comparative | 1/2 | 287 | 2.1 | 1.3 | 3 |
| Example 1-3 | | | | | |

### Comparative Example 2

Bispropagyl succinate (BPS) of formula 3 wherein R is —CH₂CH₂— was added to a difunctional hydroxyl-terminated glycidyl azide polymer (GAP) in a certain amount, as compared to the azide polymer as shown in Table 3 below, and vacuum mixed, followed by curing in an oven at 50° C.

TABLE 3

| | BPS content | | | Elastic | Hardness |
|---|---|---|---|---|---|
| | (compared to | Elongation | Tensile | modulus | (Shore |
| | GAP, wt %) | (%) | (MPa) | (MPa) | A2) |
| Comparative | 5% | Not cured | | | |
| Example 2-1 | | | | | |
| Comparative | 7% | 174 | 0.6 | 0.5 | 0 |
| Example 2-2 | | | | | |
| Comparative | 10% | 61 | 3.4 | 8.1 | 24 |
| Example 2-3 | | | | | |

### Example 1

Under the equivalence ratio (—NCO/—OH) of the hydroxyl groups at the end of the azide polymer GAP and the isocyanate curing agent IPDI (—NCO/—OH) of 1.1, TPB and DNSA were added in an amount of 0.1% and 0.05% by weight, respectively, and hydroxybutyl propiolate, HBP or BPS of formula 5 wherein R is —CH₂CH₂CH₂CH₂—, which would react with the azide in the side chain of GAP, was added as shown in Table 4 below, vacuum mixed, and cured at 50° C.

TABLE 4

| | HBP | | | Elastic | Hardness |
|---|---|---|---|---|---|
| | content | Elongation | Tensile | modulus | (Shore |
| | (wt %) | (%) | (MPa) | (MPa) | A2) |
| Example 1-1 | 2 | 177 | 5.3 | 5.1 | 28 |
| Example 1-2 | 3 | 120 | 7.6 | 10.6 | 39 |
| Example 1-3 | 4 | 87 | 8.3 | 14.9 | 44 |
| Example 1-4 | 5 | 82 | 10.6 | 19.5 | 43 |
| Example 1-5 | BPS, 0.9 | 398 | 4.8 | 1.7 | 11 |

In Example 1, the composition was designed to prepare a propellant slurry in the way that the end of GAP was connected with urethane groups by IPDI, by using HBP, an asymmetric difunctional compound, the azide of the side chain was reacted with the alkyne group at one end of HBP and the hydroxyl group at the other end of HBP was reacted with an isocyanate group, thereby finally curing the GAP through a three-dimensional network. As a result, it showed excellent mechanical properties, as compared to GAP cured only with trizol group prepared by Comparative Example 2 in Table 3. In addition, as the amount of HBP increases, even if the amount of IPDI was constant, more azide compounds in the side chains were converted to triazole groups, the connecting sites between GAP molecular chains increased, and the cross-linking density increased, thereby increasing the tensile strength of the polymer network and decreasing the elongation slightly.

### Example 2

Under the equivalence ratio (—NCO/—OH) of the hydroxyl groups at the end of the azide polymer GAP and the isocyanate curing agent IPDI of 1.1, TPB and DNSA were added in an amount of 0.1% by weight and 0.05% by weight, respectively, and the difunctional alkyne or difunctional alkene compound which would react with the azide in the side chain of GAP was added as shown in Table 5 below, vacuum mixed, and cured at 50° C. In this Example 2, each of the contents (equivalent/kg) of the alkyne or alkene reactive group reacting with the azide in the binder mixture was varied as shown in Table 5 so that their contents were the same, and it was confirmed what compound has the greatest impact on the mechanical properties of the azide polymer.

TABLE 5

| | Compound | | | | | |
|---|---|---|---|---|---|---|
| | reacting | | | | Elastic | Hardness |
| | with azide | | Elongation | Tensile | modulus | (Shore |
| | Type | wt % | (%) | (MPa) | (MPa) | A2) |
| Example | BPS | 1.65 | 161 | 4.5 | 4.3 | 25 |
| 2-1 | | | | | | |
| Example | DPCP | 5.0 | 215 | 8.3 | 6.3 | 32 |
| 2-2 | | | | | | |
| Example | PBMI | 2.27 | 195 | 5.6 | 4.2 | 23 |
| 2-3 | | | | | | |
| Example | HBP | 2.4 | 142 | 5.5 | 6.5 | 29 |
| 2-4 | | | | | | |
| Example | EDP | 1.41 | 147 | 4.5 | 4.9 | 24 |
| 2-5 | | | | | | |

DPCP: Dipropiolate polycaprolactone of formula 2 wherein R is polycaprolactone with a molecular weight of 500 g/mol.
PBMI: Phenyl bismaleimide of formula 4 wherein R is a phenyl group.
EDP: Ethylene dipropiolate of formula 2 wherein R is —CH₂CH₂—.

As shown in Table 5, a polymer network showing the best mechanical properties could be prepared by using dipropiolate polycaprolactone (DPCP) in an oligomeric form among alkyne or alkene compounds that form a network with urethane groups at the ends of the polymer chain by reaction with azide. There was no significant difference in mechanical properties between the other difunctional alkyne compounds of the same series, i.e., BPS, HBP, and EDP. Meanwhile, the mechanical properties of networks prepared by alkene compounds that form triazolines by reaction with azide, especially PBMI, an imide compound, were superior in terms of tensile and elongation, as compared to those prepared by alkyne compounds that form triazoles by reaction with azide.

### Example 3

Under an equivalence ratio (—NCO/—OH) of 1.1 between the hydroxyl groups at the end of the azide polymer GAP and the isocyanate curing agent IPDI, TPB and DNSA were added in an amount of 0.1% by weight and 0.05% by weight, respectively, and bismaleimide having an imide group as shown in formula 4, which would react with the azide in the side chain of GAP, was added as shown in Table 6, vacuum mixed, and cured at 50° C.

TABLE 6

| | | | | Elastic | Hardness |
|---|---|---|---|---|---|
| | Bismaleimide | Elongation | Tensile | modulus | (Shore |
| | (wt %) | (%) | (MPa) | (MPa) | A2) |
| Example 3-1 | MPBMI, 0.9 | 250 | 4 | 1.8 | 15 |
| Example 3-2 | PBMI, 0.9 | Cured but not separated from the mold | | | |
| Example 3-3 | PBMI, 1.50 | 226 | 3.9 | 2.5 | 16 |
| Example 3-4 | PBMI, 1.95 | 176 | 4.4 | 4 | 22 |
| Example 3-5 | PBMI, 2.27 | 126 | 5.1 | 6.3 | 31 |

MPBMI : 1,1′-(methylene di-4,1-phenylene)bismaleimide

As shown in Examples 3-2 to 3-5 in Table 6, the tensile strength of the polymer network increased and the elongation decreased due to the increased crosslinking density as the amount of imide as an alkene compound increased. In addition, GAP as an azide polymer could be cured more easily by using MPBMI comprising two phenyl groups, as compared to PBMI having only one phenyl group.

Embodiments about a solid propellant binder composition for a three-dimensional network according to the present disclosure were described above, but it is apparent that various modifications may be achieved without departing from the scope of the present disclosure.

Therefore, the scope of the present disclosure should not be limited to the embodiment(s) and should be determined by not only the following claims, but equivalents of the claims.

That is, it should be understood that the embodiments described above are not limitative, but only examples in all respects, the scope of the present disclosure is expressed by claims described below, not the detailed description, and it should be construed that all of changes and modifications achieved from the meanings and scope of claims and equivalent concept are included in the scope of the present disclosure.

What is claimed is:

1. A solid propellant binder composition comprising:
an azide polymer containing hydroxyl groups at both ends and azide groups in the side chain, as a prepolymer,
a difunctional isocyanate compound as a urethane curing agent; and
a triazole or triazoline curing agent.

2. The solid propellant binder composition according to claim 1,
wherein the azide polymer is represented by the following formula 1: 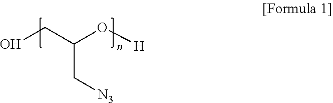
wherein in the formula 1, n is an integer from 10 to 20.

3. The solid propellant binder composition according to claim 1,
wherein the difunctional isocyanate compound is selected from the group consisting of isophorone diisocyanate (IPDI), dimeric diisocyanate (DDI), and hexamethylene diisocyanate (HDI).

4. The solid propellant binder composition according to claim 1,
wherein the triazole or triazoline curing agent is a compound selected from the group consisting of a compound comprising an alkyne group, a compound comprising an alkene group, and a combination thereof.

5. A solid propellant binder composition comprising:
an azide polymer containing hydroxyl groups at both ends and azide groups in the side chain, as a prepolymer,
a difunctional isocyanate compound as a urethane curing agent; and
a compound containing an alkyne group as a triazole curing agent,
wherein the compound containing the alkyne group is represented by the following formula 2 or formula 3: 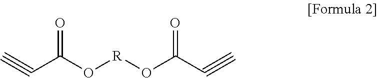
wherein in the formula 2, R is an alkylene group having 1 to 10 carbon atoms or polycaprolactone having a molecular weight of 300 to 1000 g/mol; and 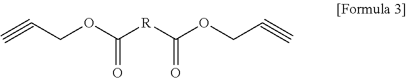
wherein in the formula 3, R is an alkylene group having 1 to 10 carbon atoms.

6. The solid propellant binder composition according to claim 5,
wherein the compound represented by formula 2 or 3 is present in an amount of 0.5 to 15% by weight with respect to the total composition.

7. A solid propellant binder composition comprising:
an azide polymer containing hydroxyl groups at both ends and azide groups in the side chain, as a prepolymer,
a difunctional isocyanate compound as a urethane curing agent; and
a compound containing an alkene group as a triazoline curing agent,
wherein the compound containing the alkene group is represented by the following formula 4: 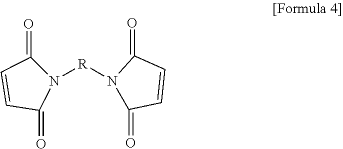
wherein in the formula 4, R is phenylene or methylene di-4,1-phenylene.

8. The solid propellant binder composition according to claim 7,
wherein the compound represented by formula 4 is present in an amount of 0.5 to 10% by weight with respect to the total composition.

9. A solid propellant binder composition comprising:
an azide polymer containing hydroxyl groups at both ends and azide groups in the side chain, as a prepolymer,
a difunctional isocyanate compound as a urethane curing agent; and
a compound containing an alkyne group as a triazole curing agent,
wherein the compound containing the alkyne group is represented by the following formula 5: 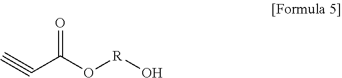
wherein in the formula 5, R is an alkylene group having 1 to 10 carbon atoms.

10. The solid propellant binder composition according to claim 9,
wherein the compound represented by formula 5 is present in an amount of 0.5 to 15% by weight with respect to the total composition.

11. The solid propellant binder composition according to claim 1,
wherein the composition comprises any one selected from the group consisting of triphenyl bismuth (TPB), di-nitro salicylic acid (DNSA), and a combination thereof, as a urethane curing catalyst.

12. A method for producing a solid propellant, comprising:
mixing the composition of claim 1 followed by curing.

13. A solid propellant comprising the composition of claim 1.
